(19) United States
(12) Patent Application Publication
(10) Pub. No.: US 2015/0261287 A1
(43) Pub. Date: Sep. 17, 2015

(54) CONSUMED ELECTRIC POWER ANALYZING APPARATUS, METHOD FOR ANALYZING CONSUMED ELECTRIC POWER, AND NON-TRANSITORY COMPUTER-READABLE RECORDING MEDIUM HAVING STORED THEREIN CONSUMED ELECTRIC POWER ANALYZING PROGRAM

(71) Applicant: FUJITSU LIMITED, Kawasaki-shi (JP)

(72) Inventor: Yukitoshi ISHIHARA, Machida (JP)

(21) Appl. No.: 14/631,325

(22) Filed: Feb. 25, 2015

(30) Foreign Application Priority Data
Mar. 13, 2014 (JP) 2014-050105

(51) Int. Cl. G06F 1/32

(52) U.S. Cl. CPC G06F 1/3287; G06F 1/3206

(57) ABSTRACT

A processor obtains a software operation log including first chronological data related to an operation history of an analysis target device; obtains a consumed electric power log including second chronological data related to an electric power value consumed by the analysis target device when carrying out software operation; determines a time correlation between time of the software operation log and time of the consumed electric power log, the time correlation being based on the first chronological data of the software operation log and the second chronological data of the consumed electric power log; and outputs the software operation log and the consumed electric power log in association with common time information based on the determined time correlation. This configuration makes it possible analyze the consumed electric power, associating the operation of the software with a change of consumed electric power.

### CROSS-REFERENCE TO RELATED APPLICATION

This application is based upon and claims the benefit of priority of the prior Japanese Application No. 2014-050105 filed on Mar. 13, 2014 in Japan, the entire contents of which are hereby incorporated by reference.

### FIELD

The embodiment discussed herein is a consumed electric power analyzing apparatus, a method for analyzing consumed electric power, and a non-transitory computer-readable recording medium having stored therein a consumed electric power analyzing program.

### BACKGROUND

In accordance with diffusion of various electronic devices such as mobile phones, smartphones, Personal Digital Assistants (PDAs), personal computers (PCS), a demand arises for reduction of electric power consumed by electronic devices. Power saving of an electronic device needs to find waste power consumption and eliminate the waste. If an electric device consumes more electric power than a value expected when designing the device, the reason for the real consumed electric power exceeding the expected value need to be analyzed and solved.

In finding unnecessary consumption electric power and analyzing the reason for the exceeding as the above, the operation history and the consumed electric power value of a target electronic device are obtained and then are correlated with each other for comparison, so that the consumed electric power can be analyzed. Here, an example of the operation history of the target electronic device to be obtained is a history of instructions related to consumed electric power issued from the Central Processing Unit (CPU) of the target electronic device.

If the operation history data related to the operation state of an target electronic device and the measured electric power data related to the electric power value consumed by the target electronic device are obtained in the same system, the operation history data and the measured electric power data are measured and recorded on the basis of time counted by a common clock. In detail, the operation history data and the measured electric power data are attached synchronization markers (synchronization indexes), which is so-called time stamps, and recorded with the markers. This make it possible to analyze, when the operation history data and the measured electric power data is correlated with each other, consumed electric power, synchronizing the operation history data with the measured electronic power by referring to the synchronization markers attached to both data pieces.

In contrast, if the operation history data and the measured electric power data are obtained by respective different systems physically remote, the operation history data and the measured electric power data are managed and recorded on the basis of time counted by respective different clocks. For example, the operation history data is obtained in the target electronic device using the clock in the target electronic device while the measured electric power data is obtained by a consumed electric power measuring device external of the target electronic device using the clock external of the target electronic device.

In such a case, it is difficult to exactly coincide the two times counted by different clocks with each other although the two times can be roughly coincide with each other. This means that the basis of time used for obtaining the operation history data is different from the basis of time used for obtaining the measured electric power data. In this case, even using the above synchronization marker (time stamp), the operation history data is not synchronized with the measured electric power data. Consequently, there is difficulty in exactly correlating the operation history data with the measured electric power data for comparison, which do not allow to precisely analyze the consumed electric power.

### SUMMARY

There is provided a consumed electric power analyzing apparatus including a first obtainer, a second obtainer, a determiner, and a merger. The first obtainer obtains a software operation log including first chronological data related to an operation history of an analysis target device. The second obtainer obtains a consumed electric power log including second chronological data related to an electric power value consumed by the analysis target device when carrying out software operation. The determiner determines a time correlation between time of the software operation log and time of the consumed electric power log, the time correlation being based on the first chronological data obtained by the first obtainer and the second chronological data obtained by the second obtainer. The merger outputs the software operation log and the consumed electric power log in association with common time information based on the time correlation determined by the determiner.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram schematically illustrating the entire configuration of the environment to which a consumed electric power analyzing apparatus according to a first embodiment is applied and examples of the hardware configuration and the functional configuration of the consumed electric power analyzing apparatus of the first embodiment;

FIG. 2 is a flow diagram schematically denoting a succession of procedural steps performed by a consumed electric power analyzing apparatus according to the first embodiment;

FIGS. 3 and 4 are flow diagrams denoting successions of procedural steps performed by a consumed electric power analyzing apparatus according to the first embodiment;

FIG. 5 is a diagram denoting an example of a software operation log;

FIG. 6 is a diagram denoting an example of a consumed electric power log;

FIG. 7 is a diagram denoting an example of CPU sleep event information extracted from a software operation log;

FIG. 8 is a diagram illustrating an example of the CPU sleep event information (CPU sleep log) of FIG. 7 expressed in the graphical form;

FIG. 9 is a diagram illustrating a manner of binarizing CPU sleep event information;

FIG. 10 is diagram illustrating the result of binarizing software operation log (CPU sleep log) of FIG. 7 and weight information applied to the software operation log;

FIG. 11 is a diagram illustrating a manner of binarizing consumed electric power log;

FIG. 12 is a diagram illustrating an example of calculating a coincidence between software operation log and consumed electric power log (when the time difference T=0);

FIG. 13 is a diagram illustrating an example of calculating a coincidence between software operation log and consumed electric power log (when the time difference T=3);

FIG. 14 is a diagram illustrating an example of evaluating the coincidence calculated in the manner of FIG. 13 using weight information;

FIG. 15 is a diagram illustrating operation performed by a merger of a consumed electric power analyzing apparatus of the first embodiment;

FIG. 16 is a diagram illustrating an example of the result of merging; and

FIG. 17 is a diagram illustrating an example of application of the first embodiment.

### DESCRIPTION OF THE PREFERRED EMBODIMENTS

Hereinafter, a consumed electric power analyzing apparatus, a method for analyzing consumed electric power, and a non-transitory computer-readable recording medium having stored therein a consumed electric power analyzing program according to a first embodiment will now be detailed with reference to accompanying drawings. The following first embodiment is exemplary and has no intention to exclude various modifications and application of techniques not referred in the first embodiment. In other words, various changes and modifications can be suggested without departing from the sprit of the first embodiment. The drawings do not illustrate therein all the functions and elements included in the embodiment and may include additional functions and elements to those illustrated in the accompanying drawings. The following embodiments can be appropriately combined in the extent that no contradiction arises in the combined procedural steps.

### (1) Overview of a Manner of Analyzing Consumption Electric Power in the First Embodiment

In analyzing consumed electric power, an operation trace log (hereinafter called software operation log) of the software in the analysis target device and a consumed electric power trace log (hereinafter called consumed electric power log) when the above software operation log is obtained are obtained. If the software operation log and the consumed electric power log are obtained in respective different systems, the software operation log is not exactly synchronized with the consumed electric power log even using synchronization markers, as described above. Consequently, the consumed electric power is not highly precisely analyzed.

With the above inconvenience in view, the first embodiment provides a manner of exactly synchronizing two trace logs with each other even under the state where the times of the two trace logs are not exactly synchronized. Specifically, the apparatus of the first embodiment exactly synchronizes two trace logs with each other by calculating a time difference between the times of recording the two trace logs using the characteristic of the trace logs without using a tag such at the above synchronization markers, and thereby the consumed electric power can be precisely analyzed. In particular as to be detailed below, this embodiment calculates the time difference (the time correlation) using the relationship that a change in amount of consumed electric power depends on a change in, for example, operation load of the CPU in the analysis target device.

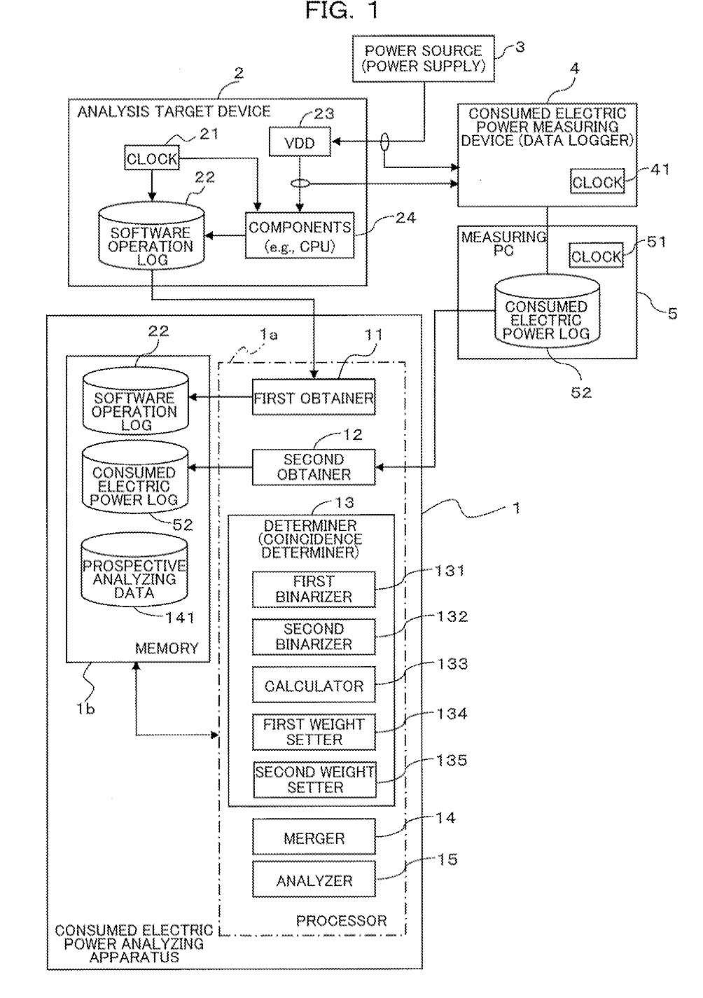

For the above, in a consumed electric power analyzing apparatus (see the reference number 1 of FIG. 1) of this embodiment, a processor (see the reference number 1a of FIG. 1) carries out at least the following steps (A1) to (A4);

(A1) obtaining a software operation log including first chronological data related to the operation history of the analysis target device;

(A2) obtaining a consumed electric power log including second chronological data related to the consumed electric power value when the analysis target device carries out software operation;

(A3) determining the time correlation (the time difference) between the times the software operation to and the consumed electric power log on the basis of the first chronological data in the software operation log and the second chronological data in the consumed electric power log; and

(A4) outputting the software operation log and the consumed electric power log associated with common time information on the basis of the determined the determined time correlation (time difference).

The above steps allow the consumed electric power analyzing apparatus of this embodiment to analyze the consumed electric power by associating the software operation with a change in the consumed electric power without using synchronization markers (synchronization indexes).

### (2) Configuration of the First Embodiment

First of all, description will now be made in relation to the entire configuration of the environment to which a consumed electric power analyzing apparatus 1 according to this embodiment is applied and examples of the hardware configuration and the functional configuration of the consumed electric power analyzing apparatus 1 by referring to FIG. 1. FIG. 1 is a block diagram schematically illustrating the entire configuration of environment to which the consumed electric power analyzing apparatus according to this embodiment is applied and examples of the hardware configuration and the functional configuration of the consumed electric power analyzing apparatus.

As illustrated in FIG. 1, the environment of measuring electric power of this embodiment includes the consumed electric power analyzing apparatus 1, an analysis target device 2, a power source 3, a consumed electric power measuring device 4, and a measuring PC 5.

Here, the consumed electric power analyzing apparatus 1 obtains a software operation log 22 and a consumed electric power log 52 of the analysis target device 2, and analyzes electric power consumed by the analysis target device 2. The detailed configuration of the consumed electric power analyzing apparatus 1 will be described below.

As described below, in the electric power measuring environment of this embodiment, the software operation log 22 and the consumed electric power log 52 of the analysis target device 2 are managed and recorded on the basis of the time counted by respective different clocks. Specifically, the software operation log 22 is obtained in the analysis target device 2 using a clock 21 included in the analysis target device 2 while the consumed electric power log is obtained by the consumed electric power measuring device 4 externally connected to the analysis target device 2 using a clock 41 or 51 also external of the analysis target device 2.

The analysis target device 2 is a device whose consumed electric power is analyzed by the consumed electric power analyzing apparatus 1 of this embodiment for improving the performance thereof, and an example of the analysis target device 2 is an electronic device such as a mobile telephone, a smartphone, a PDA, or a PC. The analysis target device 2 supplies internal components 24 with electric power received from the external power source 3 through an electric power terminal (VDD) 23. The CPU of the analysis target device 2 is included in the components 24.

The analysis target device 2 is configured to store the operation (system operation) of the software, in the form of the log 22, based on the information output from, for example, the CPU in a memory (not illustrated) included in the analysis target device 2. The software operation log 22 includes the first chronological data related to the operation history of the analysis target device 2. In the software operation log 22, the information of each event occurred in the analysis target device 2 is recorded as the first chronological data in association with the time (when the event occurs) counted by the clock 21 included in the analysis target device 2. Accordingly, the time of the software operation log 22 is the time counted by the clock 21 included in the analysis target device 2.

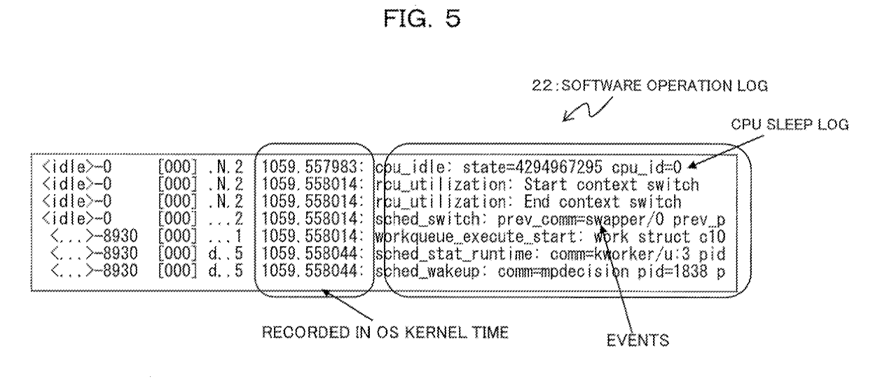

Examples of an event included in the software operation log 22 are events to be used for checking the electric power consumed by the analysis target device 2 and a CPU sleep event to be used for synchronization (time synchronization) as to be detailed below. A concrete example of the software operation log 22 will be detailed below by referring to FIG. 5.

The consumed electric power measuring device (data logger) 4 is a general versatile device and measures the electric power consumed by the analysis target device 2 by monitoring the power source (power supplier) 3, which supplies the analysis target device 2 with electric power. For this purpose, the consumed electric power measuring device 4 probes electric current between the analysis target device 2 and the power source 3 and thereby measures the electric power value consumed by the entire analysis target device 2, and probes electric current between each component 24 and the VDD 23 in the analysis target device 2 and thereby measures the electric power value consumed by each component group.

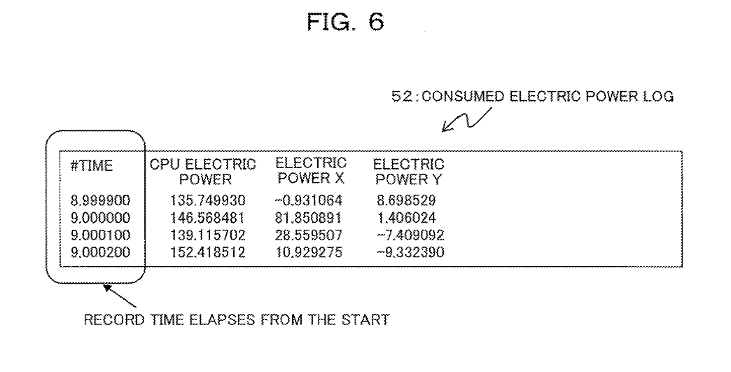

The measuring PC 5 obtains the consumed electric power log 52 of the analysis target device 2 measured by the consumed electric power measuring device 4 by controlling the consumed electric power measuring device 4. The consumed electric power log 52 includes second chronological data related to a consumed electric power value when the analysis target device 2 is carrying out software operation. In the consumed electric power log 52, the consumed electric power value measured in predetermined intervals after the measurement of the consumed electric power is started is recorded as the second chronological data in association with the time of measurement. The time of measurement of the consumed electric power log 52 may be the time counted by the clock 41 in the consumed electric power measuring device 4 or the time counted by the lock 51 in the measuring PC 5. Accordingly, the time of consumed electric power log 52 is the time counted by the clock 41 included in the consumed electric power measuring device 4 or by the clock 51 of the measuring PC 5. A concrete example of the consumed electric power log 52 will be detailed below by referring to FIG. 6.

The above clocks 21, 41, and 51 may be devices such as calendar Integrated Circuits (ICs) that non-volatilely retain the time or may be timers that start time counting when the corresponding devices are powered on or when the measurement is started. In either case where the clocks 21, 41, and 51 are calendar ICs or timers, the software operation log 22 and the consumed electric power log 52 have to be synchronized (time-synchronized).

The consumed electric power analyzing apparatus 1 of this embodiment is configured with, for example, a typical PC, and is connected to the analysis target device 2 and the measuring PC 5 via, for example, a network (not illustrated). The consumed electric power analyzing apparatus 1 is configured to be able to obtain the software operation log 22 and the consumed electric power log 52 respectively from the analysis target device 2 and measuring PC 5 via the network. An example of the network is Internet, a Local Area Network (LAN), or a Wide Area Network (WAN). The consumed electric power analyzing apparatus 1 may be configured to be an integrated form with the measuring PC 5 and in this case, it is possible to eliminate the network between the consumed electric power analyzing apparatus 1 and the measuring PC 5.

The consumed electric power analyzing apparatus 1 analyzes the electric power consumed by the analysis target device 2 on the basis of the obtained software operation log 22 and consumed electric power log 52. In the analysis, since these logs 22 and 25 are recorded on the basis of the times counted by the respective different clocks 21 and 41 (51), the consumed electric power analyzing apparatus 1 of this embodiment carries out synchronization (time synchronization) of the log 22 with the log 52.

Hereinafter, the hardware configuration and the functional configuration of the consumed electric power analyzing apparatus 1 that carries out synchronization (time synchronization) of the log 22 with the log 52.

The consumed electric power analyzing apparatus 1 includes: at least a processor 1a, such as a CPU, a Micro-Processing Unit (MPU), or a Computer and a memory 1b, such as a Random Access Memory (RAM), a Hard Disk Drive (HDD), Solid State Drive (SSD).

The processor 1a reads an application program (i.e., consumed electric power analyzing program) from the memory 1b and executes the read program to function as a first obtainer 11, a second obtainer 12, a determiner 13, a merger 14, and an analyzer 15. The application program is provided in the form of being stored in a non-transitory computer-readable recording medium, such as a flexible disk, a CD (e.g., CD-ROM, CD-R, CD-RW) a DVD (e.g., DVD-ROM, DVD-RAM, DVD-R, DVD-RW, DVD+R, DVD+RW), and a Blu-ray disk. In this case, the processor 1a reads the program from the recording medium, and then forwards and stores the read program to and into the memory 1b serving as an internal or external storage device for future use.

The memory 1b stores therein the above application program and various pieces of information to be used in processes to be performed by the processor 1a. Examples of information stored in the memory 1b is the software operation log 22 and the consumed electric power log 52 respectively obtained by the first obtainer 11 and the second obtainer 12, and prospective analyzing data 141 obtained by the merger 14. The software operation log 22, the consumed electric power log 52, and the prospective analyzing data 141 will be detailed below by referring to FIGS. 5, 6, and 16, respectively.

The first obtainer 11 obtains the software operation log 22 including the first chronological data related to the operation history of the analysis target device 2 from the analysis target device 2 and stores the obtained log 22 into the memory 1b.

The second obtainer 12 obtains the consumed electric power log 52 including the second chronological data related to the consumed electric power value when the analysis target device 2 is carrying out software operation from the measuring PC 5 and stores the obtained log 52 into the memory 1b.

The determiner (coincidence determiner) 13 determines the time correlation (time difference) between the time of the software operation log 22 and the time of the consumed electric power log 52 on the basis of the first chronological data in the software operation log 22 obtained by the first obtainer 11 and the second chronological data in the consumed electric power log 52 obtained by the second obtainer 12. Specifically, the determiner 13 binarizes the first chronological data and second chronological data into the first binary data and second binary data, and carries out pattern matching on the first binary data with the second binary data. Then the determiner 13 determines the coincidence between the first binary data and the second binary data and determines a time difference when the highest coincidence to be the time correlation.

For this purpose, the determiner 13 has functions as a first binarizer 131, a second binarizer 132, a calculator 133, a first weight setter 134, and second weight setter 135.

The first binarizer 131 binarizes the first chronological data for each analysis time. The analysis time (predetermined unit time) is set by the user or the operator, is a unit of time division on data during the analysis, and serves as a parameter that indicates the fineness of the time difference. The analysis time is a parameter leading to the precision of time synchronization between the software operation log 22 with the consumed electric power log 52, and preferably conforms to, for example, the measuring unit time of the consumed electric power measuring device 4.

The second binarizer 132 binarizes the second chronological time for each analysis time.

The calculator 133 calculates the coincidence between the first binary data and the second binary data respectively obtained by the first binarizer 131 and the second binarizer 132 by repetitiously shifting the correlation of first binary data with the second binary data by the analysis time. The calculator 133 calculates the time difference between the first binary data and the second binary data when the coincidence comes to be the maximum as the time correlation.

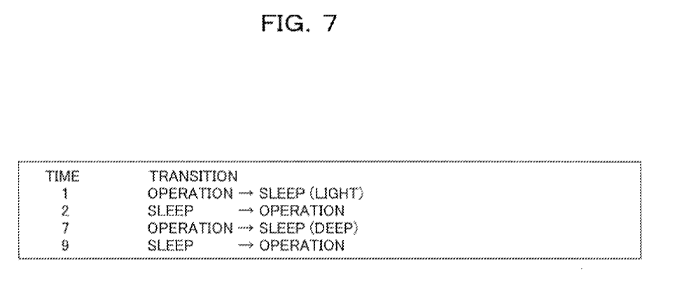

For example, the first binary data takes a value of “0” while the analysis target device 2 (i.e., the CPU included in the components 24) is in a state of sleep and takes a value of “1” while the analysis target device 2 (i.e., the CPU) is operating. Concrete examples of the first binary data is detailed below by referring to FIGS. 7-9.

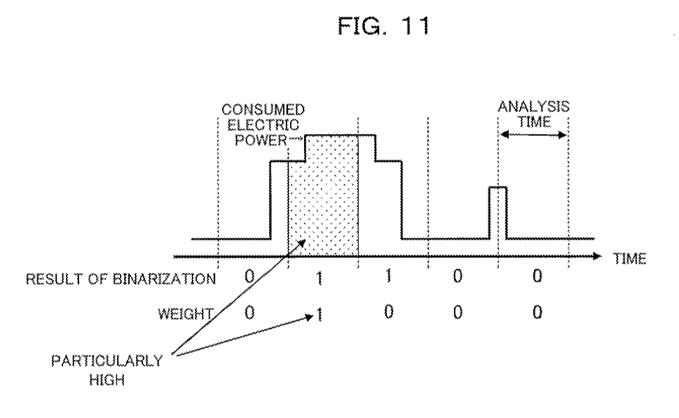

For example, the second binary data takes a value of “0” when the consumed electric power value in the analysis time is less than a first threshold while takes a value of “1” when the consumed electric power value in the analysis time is equal to or larger than the first threshold. The second binary data and the first threshold will be detailed below by referring to FIG. 11.

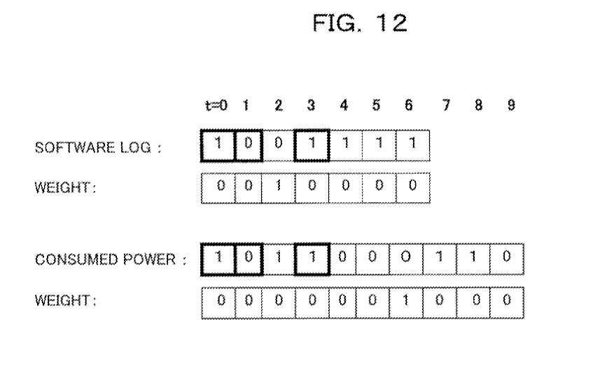

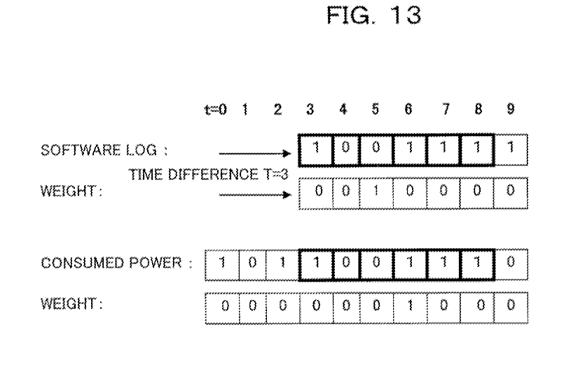

The coincidence is, for example, a ratio of the values the first binary data coinciding with the values of the second binary data to the total values within the region of correlating the first binary data with the second binary data. Concrete example of the coincidence will be detailed below by referring to FIGS. 12 and 13.

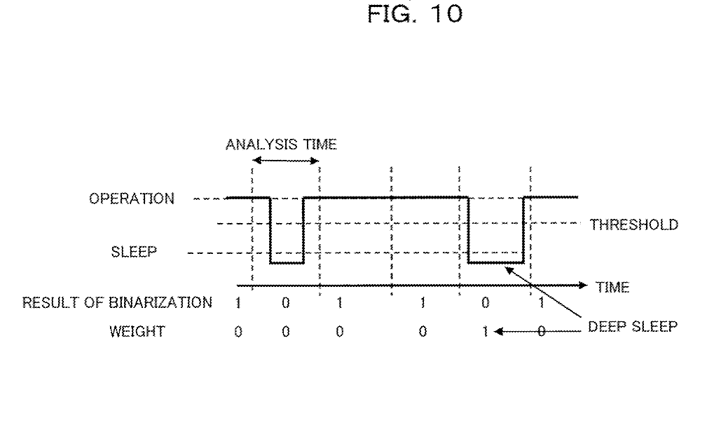

The first weight setter 134 sets first weight information in the first binary data for each analysis time when the CPU is in the state of deep sleep. As to be detailed below by referring to FIG. 10, the first weight information takes a value of “0” when the CPU is operating or in the state of light sleep where the CPU stops only the clock while takes a value of “1” when the CPU is in the state of deep sleep where the CPU stops the power supply.

The second weight setter 135 sets second weight information in the second binary data for each analysis time when the consumed electric power within the analysis time is equal to or more than a second threshold, which is larger than the first threshold. For example, as to be detailed below by referring to FIG. 11, the second weight information takes a value of “0” when the consumed electric power in the analysis time is less than the second threshold while takes a value of “1” when the consumed electric power in the analysis time is equal to or more than the second threshold.

When the relationship between the first weight information and the second binary data or the relationship between the second weight information and the first binary data satisfies a predetermined condition, the calculator 133 modifies the coincidence according to a predetermined correction standard such that the coincidence when the relationship satisfies the condition is larger than that when the relationship does not satisfy the condition.

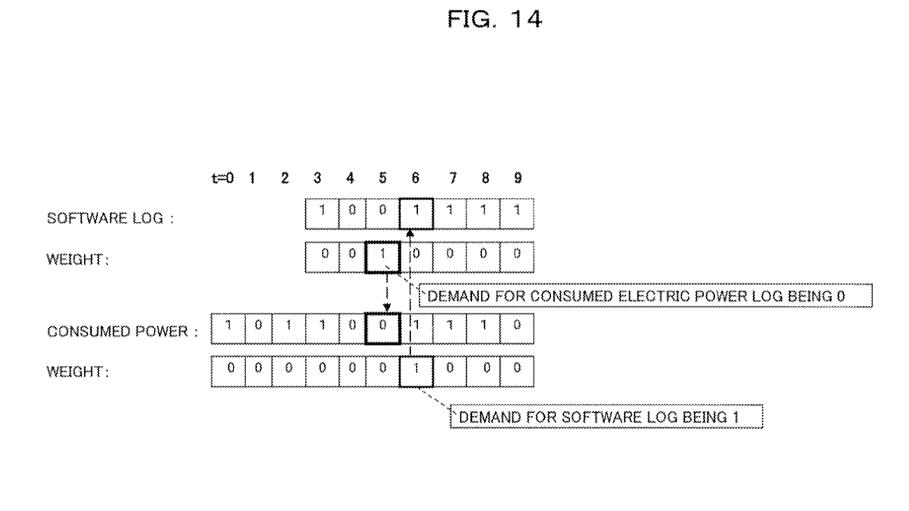

For example, the predetermined condition is that the second binary data takes a value of “0” at the time (i.e., analysis time) when the first weight information “1” is set or that the first binary data takes a value of at the time (i.e., analysis time) when the second weight information “1” is set. The predetermined condition will be detailed below by referring to FIG. 14.

The calculator 133 of this embodiment is configured so as to modify the predetermined correction standard in accordance with the measuring noise of the obtained data (first chronological data) of the software operation log 22 or the obtained data (second chronological data) of the consumed electric power log 52. For example, when the measuring noise is less than a predetermined criterion that is, when the obtained data has high reliability), the predetermined correction standard is set to be a stricter condition. In contrast, when the measuring noise is more than the predetermined criterion (that is, when the obtained data has low reliability), the predetermined correction standard is set to an easier condition.

When the measuring noise is not more or less than the predetermined criterion, i.e., in the middle state, the calculator 133 does not modify the calculated coincidence representing a ratio of the values of the first binary data coinciding with the value of the second binary data in accordance with the measuring noise, and does regard the calculated ratio without any modification as the coincidence.

The stricter condition is to multiply the coincidence by a value (e.g., 1) equal to or more than 1 when the above predetermined condition is satisfied while to multiply the coincidence by zero when the above predetermined condition is not satisfied. The easier condition is to multiply the coincidence by a value (e.g., 1.1) more than 1 when the above predetermined condition is satisfied while to multiply the coincidence by a positive value (e.g., 0.9) less than 1 when the above predetermined condition is not satisfied.

The above analysis time (predetermined unit time), the first threshold, the second threshold, the predetermined condition, and the correction standard described the above are set in advance by the user or the operator and stored in the memory 1b when the consumed electric power analyzing apparatus 1 is started or when the analysis of the consumed electric power is started.

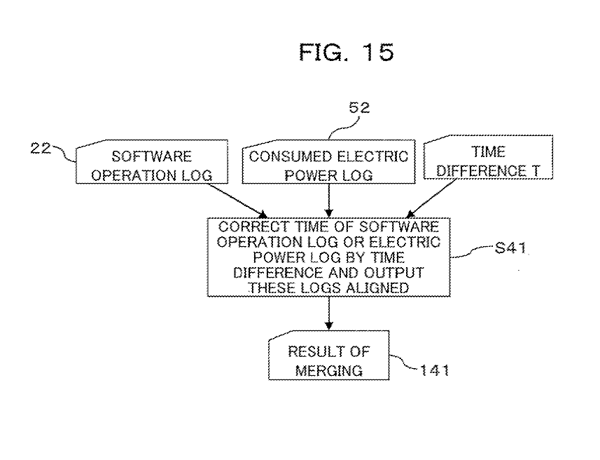

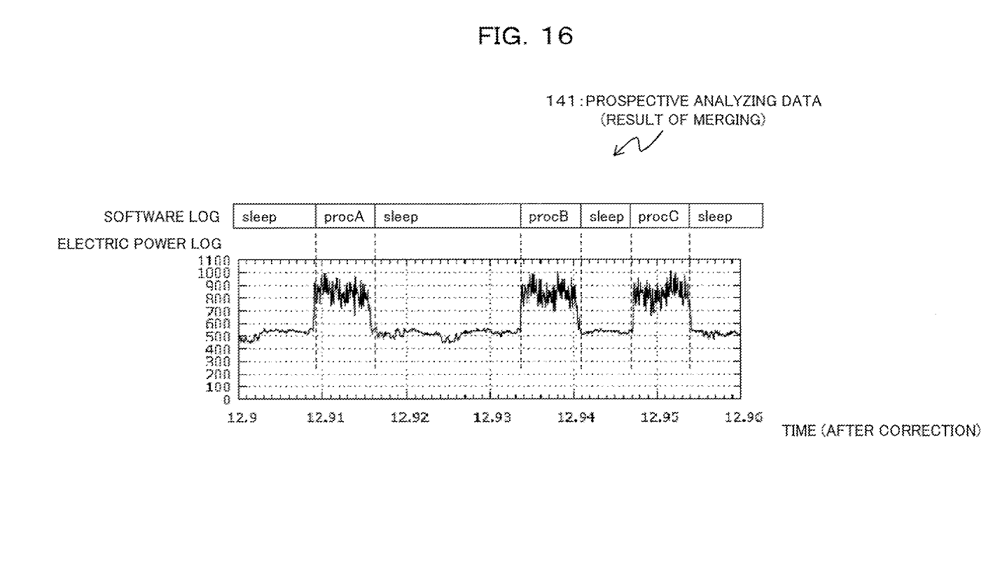

The merger 14 merges the software operation log 22 and the consumed electric power log 52 by associating the software operation log 22 and the consumed electric power log 52 with common clock information based on the time correlation (i.e., the time difference when the coincidence comes to be the largest) determined by the determiner 13 and outputs the merged logs. After that, as to be detailed below by referring to FIGS. 15 and 16, the merger 14 stores the prospective analyzing data (result of merging) 141 obtained by merging the software operation log 22 and the consumed electric power log 52 into the memory 1b.

On the basis of the prospective analyzing data 141 obtained by the merger 14, the analyzer 15 analyzes the electric power consumed by the analysis target device 2. Here, the detailed manner of the analysis is omitted, but the analyzer 15 analyzes the electric power consumed by the analysis target device 2, comparing the first chronological data (operation history) with the second chronological data (consumed electric power value), which are synchronized with each other.

### (3) Operation of This Embodiment

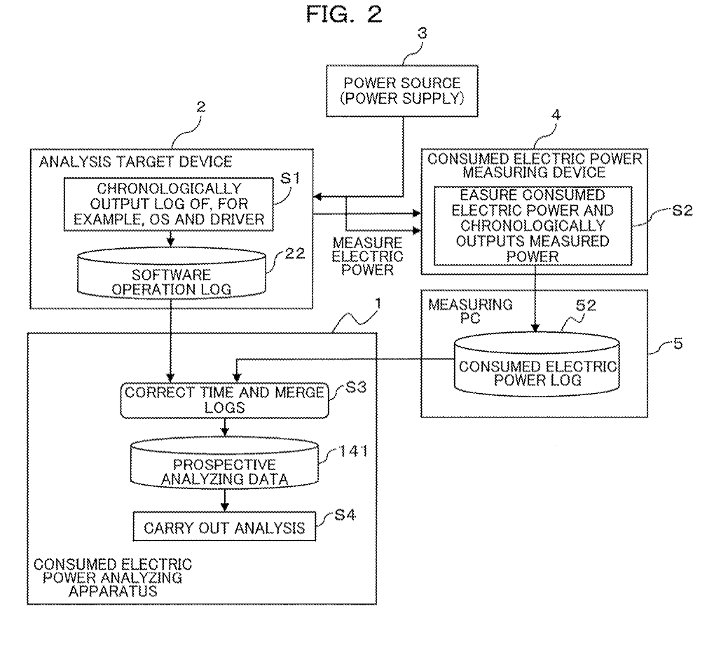

Next, description will now be made in relation to the operation of the consumed electric power analyzing apparatus 1 of this embodiment by referring to FIGS. 2-16.

First of all, the outline of a succession of procedural steps performed using the consumed electric power analyzing apparatus 1 of this embodiment is schematically described along the flow diagram FIG. 2 (steps S1-S4).

In the analysis target device 2, before the consumed electric power analyzing apparatus 1 starts the procedure, the log of, for example, the operation of the operating system (Os) and the drivers are chronologically output (step S1) on the basis of the time of the clock 21 (see FIG. 1) and are stored as the software operation log 22.

In parallel with obtaining the software operation log 22, the consumed electric power measuring device 4 measures the electric power consumed by the analysis target device 2. The measured electric power value is chronologically output (step S2) on the basis of the time of, for example, the clock 41 (see FIG. 1) and stored as the consumed electric power log 52 in the measuring PC 5.

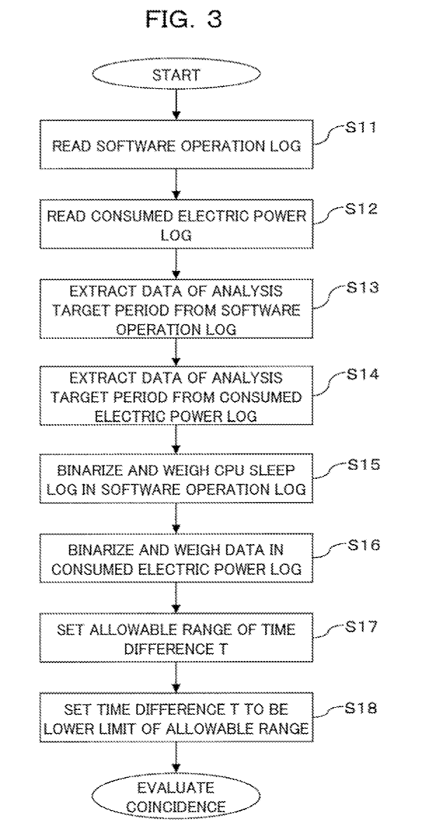

After that, when starting the analysis, the consumed electric power analyzing apparatus 1 obtains the software operation log 22 stored in the analysis target device 2 and the consumed electric power log 52 stored in the measuring PC 5. Then the consumed electric. power analyzing apparatus 1 carries out time correction (synchronization/time synchronization) on obtained the software operation log 22 and consumed electric power log 52 and the merges the logs (step S3). The detailed operation performed in step S3 will be detailed below by referring to FIGS. 3-16.

The result 141 of merging the software operation log and the consumed electric power log 52 in step S3 is used as prospective analyzing data in the analyzer 15 so that the electric power consumed by the analysis target device 2 is analyzed (step S4).

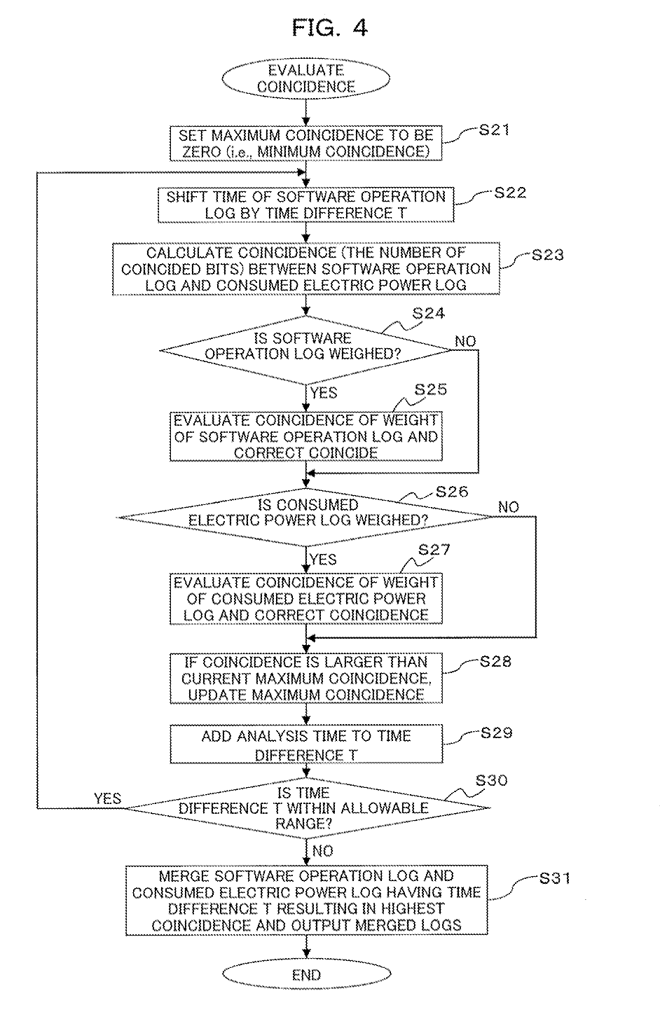

Next, description will now be made in relation to the operation of consumed electric power analyzing apparatus 1 of this embodiment along the flow diagrams FIGS. 3 and 4 (i.e., steps S11-S19 and S21-S31) by referring to FIGS. 5-16.

When the consumed electric power analyzing apparatus 1 is started or analysis of the consumed electric power is started, the first obtainer 11 obtains the software operation log 22 including the first chronological data related to the operation history of the analysis target device 2 from the analysis target device 2 and stores the software operation log 22 into the memory 1b (step S11 of FIG. 3). Besides, the second obtainer 12 obtains the consumed electric power log 52 including the second chronological data related to the consumed electric power value when the analysis target device 2 is carrying out software operation from the measuring PC 5 and stores the consumed electric power log 52 into the memory 1b (step S12 of FIG. 3). Steps S11 and S12 may be carried out in parallel or step S12 may be carried out before step S11. The “software operation log” is sometimes abbreviated to “soft log” or “soft operation log” in the following description and drawings. Likewise, the “consumed electric power log” is sometimes abbreviated to “electric power log” of “consumed electric power” in the following description and drawings.

Here, the software operation log 22 includes, as the first chronological data, events to be analyzed and the CPU sleep event (sleep log). Events to be analyzed are used for analysis by the analyzer 15 after the time synchronization (synchronization) is accomplished. The CPU sleep log is used for the time synchronization (synchronization). FIG. 5 is a diagram illustrating an example of the software operation log 22. The time of the software operation log 22 illustrated in FIG. 5 is the OS kernel time counted by the clock 21, which means that the time that has elapsed since the device 1 has been started (power on). Each event is an event seen from the OS kernel of the recorded time, and in the example of FIG. 5, the “cpu_idle” event is used as the CPU sleep log. Even if the software operation log 22 contains events not to be used for the analysis or the time synchronization, these events do not affect the analysis and the time synchronization because the processor 1a does not refer to these events. FIG. 5 is a diagram denoting an example of the software operation log 22.

The consumed electric power log 52 includes a consumed electric power value (measured electric current data) measured at predetermined time interval (for each analysis time) after the start of measuring the electric power. In the consumed electric power log 52, the consumed electric power value is recorded in association with the time of measurement and is recorded as the second chronological data. This embodiment presumes that the electric power (electric current) consumed by the CPU in the analysis target device 2 can be measure with, for example, a lead connected to the substrate of the analysis target device 2. The electric power log 52 including the measured consumed electric power value is used for the time synchronization (synchronization) with the soft log 22. If the electric power consumed solely by the CPU is not able to be measured, the electric power consumed at the battery terminal may be measured as the second chronological data of the electric power log 52 in place of the electric power consumed solely by the CPU. FIG. 6 is a diagram denoting an example of the consumed electric power log 52. The time of the electric power log 52 depicted in FIG. 6 is measured by the clock 41 or 51 and is time elapsed from the start of the measurement. The electric power log 52 records therein consumed electric power values X and Y, which are measured at two points in the analysis target device 2 in addition to the electric power consumed by the CPU.

Then, the first obtainer 11 extracts data of an analysis target period from the software operation log 22 (step S13 of FIG. 3) and the second obtainer 12 extracts data the analysis target period from the consumed electric power log 52 (step S14 of FIG. 3). The steps S13 and S14 may be carried out in parallel, or the step S14 may be carried out before step S13.

Since the start and end portions of measured data generally contain noise and unnecessary operation, such noise and operation are preferably removed before the analysis is carried out. A normal object of the analysis is to analyze electric rower consumed when a particular operation is performed or when a particular phenomenon occurs. For the above, narrowing the analysis target period into a period during which such an event or operation occurs can shorten the time for process and avoid mistake in time synchronization of the logs 22 and 52 with an incorrect time basis, so that the precision of the analysis can be enhanced. Accordingly, the analysis target period of the software operation log 22 is previously selected and set by a user or an operator on the basis of the time period during which an event of the target of time synchronization occurs and a viewpoint including an event suitable for time synchronization, and is stored in the memory 1b. The analysis target period of the consumed electric power log 52 is also previously selected and set in the same manner as that of the software operation log 22.

Then the first binarizer 131 binarizes the CPU sleep log (first chronological data) included in the analysis target period of the software operation log 22 for each analysis time and thereby generates the first binary data. The first weight setter 134 sets the first weight information “1” for the first binary data of each analysis time if the CPU is in the state of deep sleep in the analysis time (step S15 of FIG. 3).

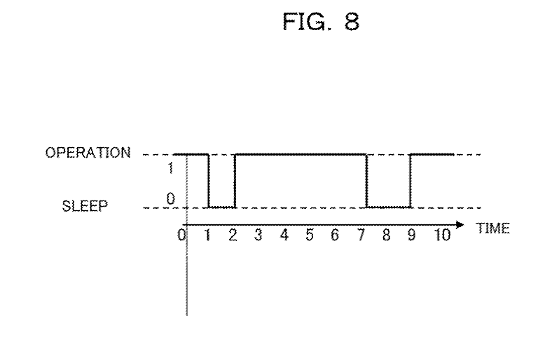

At this time, the first binarizer 131 extracts transition information (see, for example, the CPU sleep log of FIG. 5) indicating that the CPU in the analysis target device 2 has moved to a state of “operating” or “sleeping” from the software operation log 22. The transit information (CPU sleep event information) extracted from the software operation log 22 is denoted in FIG. 7. FIG. 8 illustrates the graph form of the CPU sleep event (CPU sleep log) in FIG. 7 taking a value of “1” when the CPU is operating while taking a value of “0” when the CPU is sleeping. The “deep” and “light” sleep in FIG. 7 represents the sleep level (i.e., C state) of the CPU.

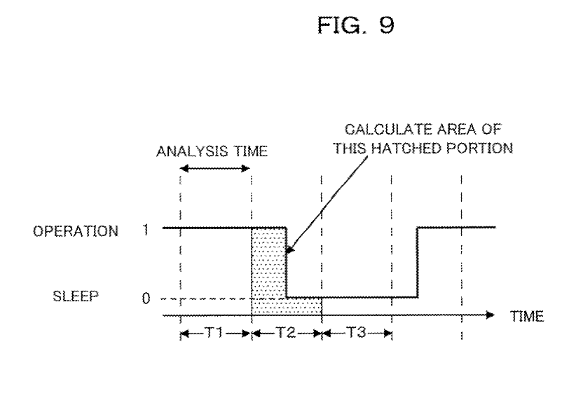

The first binarizer 131 delimits the graph obtained as illustrated in FIG. 8 in the time-axis direction at the intervals of the analysis time and binarizes each interval of the CPU sleep event information, as illustrated in FIG. 9, in accordance with the area of the interval being equal to or larger than a threshold. The threshold used here is, for example, an average value of the maximum value and the minimum value of the areas of the above intervals. The maximum value corresponds to the area of the interval T1 of FIG. 9 while the minimum value corresponds to the area of the interval T3. In this example, the first binarizer 131 sets the first binary data of the interval T1 to be “1”; that of the interval T3 to be “0”; and that of the interval T2 to be “1” or “0” based on the above threshold. FIG. 9 is a diagram illustrating a manner of binarizing the CPU sleep event information.

The result of binarization along the above binarization manner and weighing by the first weight setter 134 on the example of the CPU sleep log denoted in FIGS. 7 and 8 is illustrated in FIG. 10. The first weight setter 134 attaches the first weight information to the software operation log 22 binarized as denoted in FIG. 10 for each analysis time if the CPU is in the state of deep sleep. For example, the weight takes a value of “0” when the CPU is operating and is in the state of light sleep where the CPU stops only the clock while takes a value of “1” when the CPU is in the state of deep sleep where the CPU stops power supply. As illustrated in the lower portion of FIG. 10, the binarization and weighing obtains a bit string of the binary data indicating the state of the CPU being operating or sleeping and a bit string of the weight information indicating the deepness of the sleep in relation to the software operation log 22. FIG. 10 is a diagram denoting the result of the binarization of the software operation log 22 and the weight information applied to the software operation log 22.

Then, the second binarizer 132 binarizes the measured electric power data (second chronological data) of the consumed electric power log 52 during the analysis target period for each analysis time and thereby generates the second binary data. As described above, the second binary data takes a value of “0” when the consumed electric power value in the analysis time is less than the first threshold while takes a value of “1” when the consumed electric power value is equal to or more than the first threshold. The second weight setter 135 sets the second weight information “1” in the second binary data for each analysis time when the consumed electric power value in the analysis time is equal to or more than the second threshold, which is larger than the first threshold (step S16 of FIG. 3).

Here, the result of binarizing the measured electric power data (consumed electric power value) of the consumed electric power log 52 is expressed by, for example, the graph of FIG. 11 in which the abscissa represents the time and the ordinate represents the consumed electric power value. Then the second binarizer 132 delimits the graph of FIG. 11 in the time-axis direction at the intervals of the analysis time, calculates the area of each interval representing the consumed electric power, and binarizes the consumed electric power log 52 in accordance with the area being equal to or larger than the first threshold. Specifically, the second binary data takes a value of “1” when the area is equal to or more than the first threshold while takes a value of “0” when the area is less than the first threshold. The first threshold used here is determined on the basis of, for example, the average value of areas of the intervals in the proximity of the interval being currently focused. FIG. 11 is a diagram denoting a manner of binarization of the consumed electric power log 52.

Further, the second weight setter 135 attaches the second weight information representing the consumed electric power is particularly high to the consumed electric power log 52 binarized as illustrated in FIG. 11 for the analysis time. The state where “the consumed electric power is particularly high” can be regarded as, for example, cases where the area of an interval currently being focused is equal to or larger than the second threshold larger than the first threshold or cases where the peak value of the consumed electric power of the interval currently being focused is equal to or larger than a predetermined value. The weight of “1” is applied to an interval whose consumed electric power is particularly high and the weight of “0” is applied to en interval whose consumed electric power is not particularly high. Consequently, as denoted in the lower portion of FIG. 11, a bit string of the binary data indicating the height of the consumed electric power and a bit string indicating whether the consumed electric power is particularly high in relation to the consumed electric power log 52 are obtained.

The above steps S15 and S16 may be carried out in parallel, or step S16 may be carried out before step S15 is carried out.

After that, an allowable range of the time difference T between the software operation log 22 and the consumed electric power log 52 are set (step S17 of FIG. 3). The time difference T is set to be the lower limit (minimum value) of the allowable range (step S18 of FIG. 3) and then the consumed electric power analyzing apparatus 1 (processor 1a) moves into a coincidence evaluation procedure denoted in FIG. 4. Here, the allowable range of the time difference T is set by the user and the operator and is a parameter of a possible range of the time difference T between the software operation log 22 and the consumed electric power log 52. The obtaining of the software operation log 22 and the consumed electric power log 52 is started substantially concurrently with the start of the analysis target device 2 and the consumed electric power measuring device 4 (the measuring PC 5), respectively. Therefore, the time difference between the time standard of the software operation log 22 and the time standard of the consumed electric power log 52 can be roughly estimated. Accordingly, this embodiments assigns this roughly-estimated time difference to the allowable range of the time difference T in advance, so that the time for determining the coincidence can be shortened without declining the accuracy of determination of the coincidence.

Next, description will now be made in relation to the determination of the coincidence by the processor 1a (the calculator 133) with reference to FIG. 4.

First of all, the minimum value 0 of the coincidence is set as the initial valve in a predetermined region of, for example, the memory 1b that stores therein the maximum coincidence value “max” (step S21).

The calculator 133 shifts the software operation log with respect to the consumed electric power log 52 by the time difference T set in the step S18 of FIG. 3 (step S22) and calculates the coincidence (the number of coinciding bits or the ratio of coinciding bits to the total bits) between the software operation log 22 and the consumed electric power log 52 (step S23). The calculator 133 determines whether a weight is set for the software operation log 22 (step S24). If the software operation log 22 is weighed (YES route in step S24), the calculator 133 evaluates the coincidence of the weight of the software operation log 22 and corrects the coincidence in the manner to be detailed below (step S25).

After the coincidence is corrected in step S25 or if the software operation log 22 is not weighed (NO route in step S24), the calculator 133 determines whether a weight is applied for the consumed electric power log 52 (step S26). If the consumed electric power log 52 is weighed (YES route in step S26), the calculator 133 evaluates the coincidence of the weight of the consumed electric power log 52 and corrects the coincidence in the manner to be detailed below (step S27).

After the coincidence is corrected in step S27 or if the consumed electric power log 52 is not weighed (NO route in step S26), the calculator 133 executes the step S28. In step S28, the calculator 133 determines whether the coincidence calculated in step S23 is larger than the current maximum coincidence “max” stored in the predetermined region. If the calculated coincidence is larger than the current maximum coincidence “max”, the calculator 133 updates the maximum coincidence “max” stored in the predetermined value to the coincidence calculated in step S23 and stores the time difference T corresponding to the calculated maximum value in association with the maximum coincidence value “max”. After that, the calculator 133 moves the procedure to step S29. In contrast, if the calculated maximum value is equal to or less than the current maximum coincidence value “max”, the calculator 133 does not update the maximum coincidence “max” and moves the procedure to step S29.

The calculator 133 adds the analysis time to the current time difference T (step S29) and determines whether the new time difference T obtained by the addition of the analysis time is within the allowable range set in step S17 of FIG. 3 (step S30). If the new time difference T is within the allowable range (YES route in step S30), the calculator 133 returns the procedure of the step S22, and repeats the procedure of the steps S22-S30. If the new time difference T is not within the allowable range (No route in step S30), the merger 14 associates the software operation log 22 shifted by the time difference T which has the highest coincidence is obtained by the calculator 133 and the consumed electric power log 52 in association with common time information (step S31). Here, the time difference T which has the highest coincidence obtained by the calculator 133 is the maximum coincide “max” finally stored in the predetermined region.

The above procedure of evaluation of the coincidence described by referring to FIG. 4 will now be further detailed by referring to FIGS. 12-16.

In this embodiment, the coincidence of bit patterns is calculated on the bit strings obtained by delimiting the software operation log 22 and the consumed electric power log 52 for each analysis time and binarizing the delimited bit patterns. Specifically, within the allowable range of the time difference T, the software operation log 22 is repetitiously shifted with respect to the consumed electric power log 52 by the analysis time, the coincidence between the shifted software operation log 22 and the consumed electric power log 52 is calculated for each time the software operation log 22 is shifted, and the time difference T when the coincidence is determined and adapted to be the highest is the time difference between the software operation log 22 and the consumed electric power log 52.

The coincidence is calculated by the calculator 133 along the procedures (B1)-(B3) of steps S23-S27 of FIG. 4.

(B1) The calculator 133 sets a comparison target region of the bit strings in which both the software operation log 22 and the consumed electric power log 52 are effective.

(B2) the calculator 133 compares the bit string of the software operation log 22 with the bit string of the consumed electric power log 52 in the comparison target region and calculates the ratio of coinciding bits as the coincidence.

(B3) If the software operation to 22 or the consumed electric power log 52 has a bit having a weight set to be “1” in the comparison target region where the software operation log 22 is compared with the consumed electric power log 52, the calculator 133 evaluates the weight and calculates the final coincidence.

In the above procedure (B3) (i.e., steps S25 and S27 of FIG. 4), the evaluation (correction) of the coincidence of the weight is carried out along the following procedures (C1) and (C2) by the calculator 133.

(C1) Under the states where a weight “1” is set in a bit of the software operation log 22, if the binary data of the consumed electric power log 52 corresponding to the bit having the weight “1” of the software operation log 22 is set to be “0”, the calculator 133 adds a bonus to the coincidence while if the corresponding binary data of the consumed electric power log 52 is not set to be “0”, the calculator 133 adds a penalty to the coincidence.

(C2) Under the states where a weight “1” is set in a bit of the consumed electric power log 52, if the binary data the software operation log 22 corresponding to the bit having the weight “1” of the consumed electric power log 52 is set to be “1”, the calculator 133 adds a bonus to the coincidence while if the corresponding binary data is not “1”, the calculator 133 provides a penalty to the coincidence.

The bonus and the penalty (predetermined correction standard) used in evaluation of the coincidence described above can be determined on the basis of the measuring precisions of the logs 22 and 52.

For example, if grasping that the obtained data in the logs 22 and 52 has low measuring noise and is precise, the calculator 133 sets strict bonus and penalty (correction standard). For example, the calculator 133 determines the multiplying the coincidence by “1” as the bonus and the multiplying the coincidence by “0” as the penalty. If the penalty is multiplying the coincidence by “0”, the bonus is satisfactory multiplying the coincidence by a value larger than “0”. In other words, under the restrict correction standard, the calculator 133 corrects the coincidence to “0” unless the value of the weight and the values of the binary data are not satisfy the predetermined condition of the weight.

In contrast, if grasping that the obtained data in the logs 22 and 52 has high measuring noise and is not precise, the calculator 133 sets mild bonus and penalty (correction standard). For example, the calculator 133 determines multiplying the coincidence of a value larger than one (e.g., 1.1) as the bonus and determines multiplying the coincidence of a value less than one (e.g., 0.9) as the penalty.

Here, an example of evaluating the coincidence will now be described by referring to FIGS. 12 and 13.

FIG. 12 is a diagram describing an example of calculating the coincidence between the software operation log 22 and the consumed electric power log 52 when the time difference T is zero. In other words, FIG. 12 is an example of bit strings of the software operation log 22 and the consumed electric power log 52 the times of which are not shifted.

In the example of FIG. 12, three bits (surrounded by the thick frames) among seven bits of the software operation log 22 coincide with the three bits (surrounded by the thick frames) of the consumed electric power log 52, so that the coincidence is calculated to be 3/7. Here, the weight “1” is set for the bit of time t=2 of the weight of the software operation log 22 while the value “1” is set for the bit of time t=2 of the consumed electric power log 52. This means that the consumed electric power log 52 exceeds the first threshold at a timing when the software operation log 22 indicates deep sleep and therefore the weight condition (predetermined condition) is not satisfied. If the restrict correction standard (restrict weight evaluation) is adopted here, the coincidence is calculated to be 3/7×0=0.

FIG. 13 is a diagram illustrating an example of calculating the coincidence between the software operation log 22 and the consumed electric power log 52 when the time difference T is three. In other words, FIG. 13 illustrates bit string of the software operation log 22 and the bit string of the consumed electric power log 52 the time of which is shifted by three unit times (three analysis times).

In the example of FIG. 13, six bits (surrounded by the thick frames) among seven bits of the software operation log 22 coincide with the six bits (surrounded by the thick frames) of the consumed electric power log 52, so that the coincidence is calculated to be 6/7. Here, the weight “1” is set for the bit of time t=5 of the weight of the software operation log 22 while the value “0” is set for the bit of time t=5 of the consumed electric power log 52. This means that the consumed electric power log 52 indicates a state of low consumed electric power at a timing when the software operation log 22 indicates deep sleep and therefore the weight condition (predetermined condition) is satisfied. In addition, the weight “1” is set for the bit of time t=6 of the consumed electric power log 52 while the value “1” is set for the bit of time t=6 of the software operation log 22. This means that the software operation log 22 indicates that the CPU is operating at the timing when the consumed electric power log 52 indicates that the consumed electric power is particularly high, so that the weight condition (predetermined condition) is satisfied. Accordingly, if the restrict correction standard (restrict weight evaluation) is adopted here, the coincidence is calculated to be 6/7×1=6/7.

Here, the “weight” of the present invention will now be detailed by referring to FIG. 14. FIG. 14 is a diagram describing evaluation (coincide correction) using the weight information in the example of calculating the coincidence of FIG. 13. In this example, the “weight” represents that the waveforms of the respective logs 22 and 52 are particularly high or particularly low.

In this embodiment, since the logs 22 and 52 represents different physical values and the binary data of the logs 22 and 52 have meaningless, the logs 22 and 52 are compared with each other, focusing on the deviation of “increasing” or “decreasing” of the physical values. In other words, binarizing the chronological data of the software operation log 22 and consumed electric power log 52 into binary bit strings drops the data volume. However, the waveform of the consumed electric power sometimes clearly has a peak, which is too useful to be discarded, and therefore is captured in the concept of “weight”.

The weight “1” of the consumed electric power log 52 represents that the consumed electric power at the timing for which the weight “1” is provided was particularly high. As illustrated in FIG. 14, at the timing for which the weight “1” is set in the consumed electric power log 52, the CPU of the analysis target device 2 should be not in the sleep state but be operating (i.e., having the binary data “1”). Therefore if the CPU is operating (i.e., the corresponding binary data is “1”) at the timing for which the weight “1” is set in the consumed electric power log 52, the consumed electric power analyzing apparatus 1 corrects the coincidence by providing the bonus. In contrast, if the CPU is not operating (i.e., the binary data is “0” at the above timing, the consumed electric power analyzing apparatus 1 corrects the coincidence by providing the penalty.

The same is applied to the “weight” of the software operation log 22. The weight of the software operation log 22 being “1” means that the CPU was in the state of deep sleep at the timing for which the weight “1” is applied. As illustrated in FIG. 14, the electric power consumed by the analysis target device 2 is low (i.e., the binary data being “0” at this timing. For the above, if the consumed electric power of the CPU indicates the low state (i.e., the binary data being “0”) at the timing for which the weight “1” is set in the software operation log 22, the consumed electric power analyzing apparatus 1 corrects the coincidence by adding a bonus. In contrast, if the consumed electric power of the CPU indicates high state (i.e., the binary data being “1”) the consumed electric power analyzing apparatus 1 corrects the coincidence by applying a penalty.

The example of FIG. 14 is the same example as FIG. 13. As described above by referring to FIG. 13, the weights “1” is set at times t=5, 6, and, at the both timing, the values “0” and “1” expected to be the values of the binary data of the logs 52 and 22, respectively are set. This means that, in the example of FIG. 14, the values of the weights and the values of the binary data satisfy the condition (predetermined condition, the calculator 133 does not correct the coincident by increasing or decreasing.

As the above, the value of the maximum coincidence “max” when the coincidence becomes the maximum is determined to be the time difference T (time correspondence) between the software operation log 22 and the consumed electric power log 52. After the time difference T is determined, the merger 14 merges the times of the logs 22 and 52 in association with a single standard time at the determined time difference T and outputs the merged logs 22 and 52. For example, as illustrated in FIG. 15, the merger 14 shifts the time of the software operation log 22 or the consumed electric power log 52 by the time difference T to merge the logs 22 and 52 and outputs the merged software operation log 22 and consumed electric power log 52 the time of one of which has been shifted as prospective parallel analyzing data (result of the merging) 141 (see step S41; step S31 of FIG 4). Thereby the analyzer 15 correlates the two logs 22 and 52 with each other at an exact timing on the basis of the result 141 of merging from the merger 14 and compares the meaning of the logs 22 and 52. FIG. 15 is a diagram illustrating the operation of the merger 14 in the consumed electric power analyzing apparatus 1 of this embodiment.

FIG. 16 illustrates an example of the result (prospective analyzing data) 141 of the merging output from the merger 14. FIG. 16 illustrates an example in the form of a chronological graph in which the times of the software operation log 22 and the consumed electric power log 52 are corrected. The example of FIG. 16 indicates that, when three processes A, B, and C (procA, procB, and procC) are executed, being interposed by sleep states, the consumed electric power increases when the processes are being carried out.

### (4) Effects of this Embodiment

According to this embodiment, on the basis of the software operation log 22 (i.e., first chronological data) and the consumed electric power log 52 (i.e., second chronological data), the time difference between the software operation log 22 and the consumed electric power log 52 is determined. Then, the software operation log 22 and the consumed electric power log 52 are output in association of the times of the both logs 22 and 52 with the common time information based on the determined time difference. This makes the consumed electric power analyzing apparatus 1 possible to analyze the consumed electric power in association with the operation of the software with a change in consumed electric power, using the characteristics of the logs 22 and 52 without using a synchronization maker (synchronization index). Consequently, the software operation log 22 can be exactly compared with the consumed electric power log 52, so that the consumed electric power can be precisely analyzed.

In this embodiment, the coincidence of the software operation log 22 and the consumed electric power log 52 are calculated on the basis of the binary data of the logs 22 and 52, and the weight information representing the state of deep sleep of the CPU and the state of particularly high consumed electric power is introduced into the calculated coincidence. If the weight information set for each of the logs 22 and 52 and the corresponding binary data satisfies the predetermined condition, a bonus is provided to the calculated coincidence. Thereby, the coincidence, which is calculated on the basis of the pattern matching the first and second binary data, is corrected on the basis of whether the predetermined conditions based on the characteristics of the respective logs 22 and 52 are satisfied, so that the time difference T between the software operation log 22 and the consumed electric power log 52 can be more exactly calculated and determined.

In this embodiment, the consumed electric power log 52 of the analysis target device 2 is obtained by the external consumed electric power measuring device 4, but may be obtained by an electric power measuring device incorporated in the analysis target device 2. In this case, the software operation log 22 and the consumed electric power log 52 can be obtained by using the same clock 21. However, if such an electric power measuring device is incorporated in a compact analysis target device 2, such as a smartphone, the electric power measuring device needs to be very compact, which results in measured electric power rougher than the case where the consumed electric power log 52 is measured with an external device. This has a possibility that the software operation log 22 and consumed electric power log 52 are not exactly compared. Even in this case, the consumed electric power analyzing apparatus 1 allows the software operation log 22 and the consumed electric power log 52 to be exactly compared.

Furthermore, in this embodiment, if the obtained data of the logs 22 and 52 has low measuring noise and is therefore highly reliable, a restrict correction standard is set while if the obtained data of the logs 22 and 52 has high measuring noise and is therefore low reliable, an easier correction standard is set. Thereby, the measuring noise (i.e., the reliability of the obtained data) is considered by correcting the coincidence in accordance with the correction standard matching the measuring noise, so that the reliability of the time difference T determined by the determiner 13 can be enhanced.

Further, the first embodiment narrows the analysis target period to a period during which events and operations that can be the objects for analyzing consumed electric power occur can greatly reduce the time for the determination of the time difference T and the analysis of the consumed electric power. In addition, this can eliminate the possibility of misjudgment that the time standards of the logs 22 and 52 are adjusted to incorrect time, so that the precision of the analysis can be further enhanced.

As described above, the obtaining of the software operation log 22 and the consumed electric power log 52 starts substantially concurrently with the start of the analysis target device 2 and the consumed electric power measuring device 4 (the measuring PC 5), respectively. Therefore, it is possible to estimate a rough time difference between the time standard of the software operation log 22 and the time standard of the consumed electric power log 52. Considering the above, this embodiment assigns a range of such a rough time difference to the allowable range of the time difference T in advance, so that the determination of the coincidence can be accomplished in a short time without lowering the precision of the coincidence determination.

### (5) Others

A preferred embodiment of the present invention is detailed as above. However, the present invention is no by means limited to the foregoing embodiment and various changes and modification can be suggested without departing from the spirit of the present invention.

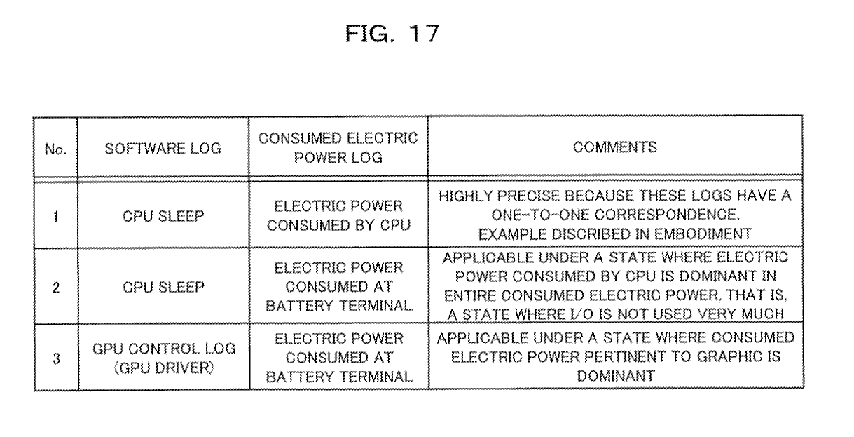

In the above embodiment, the time of the software operation log 22 representing the CPU sleep information is synchronized with the time of the consumed electric power log 52 of the CPU. But, the combination of logs is not limited to this. FIG. 17 is a diagram illustrating an example of application of the first embodiment. In FIG. 17, No. 1 corresponds to the above embodiment. In the combination of logs of No. 1, the CPU sleep state one-to-one corresponds to the electric power consumed by the CPU, which means that the combination is highly precise.

For example, as denoted of No. 2 in FIG. 17, the consumed electric power analyzing apparatus 1 can compare the consumed electric power log of a battery terminal with the CPU sleep log. In this case, the consumed electric power is the sum of the electric power consumed by components (e.g., a Graphics Processing Unit (GPU)) except for the CPU and the electric power consumed by the CPU, which means the consumed electric power log does not always accord with the state of the CPU sleep log. However, since the CPU controls the other devices, the CPU sleep log generally tends to accord with the consumed electric power log and therefore adjusting an allowable parameter and measuring having less disturbance make it possible to use the combination of logs of No. 2. In addition, the combination of the logs of No. 2 is applicable under a state where the electric power consumed by CPU is dominant in entire consumed electric power, that is, a state where the Input/Output (I/O) device is not used very much.

Likewise, except for the CPU sleep log, a phenomenon correlated with increase and decrease of consumed electric power can be applied to the software operation log 22. For example, as denoted in No. 3 of FIG. 17, limiting to a graphic drawing process, adjusting the precision and a parameter make it possible to use a GPU control log and an consumed electric power log at the battery terminal as the logs 22 and 52, respectively and carry out time synchronization. The combination of No. 3 is applicable under a state where the consumed electric power pertinent to graphic is dominant.

According to the above embodiment, the consumed electric power can be analyze, associating the operation of the software with a change of consumed electric power.

All examples and conditional language provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A consumed electric power analyzing apparatus comprising:
a first obtainer that obtains a software operation log including first chronological data related to an operation history of an analysis target device;
a second obtainer that obtains a consumed electric power log including second chronological data related to an electric power value consumed by the analysis target device when carrying out software operation;
a determiner that determines a time correlation between time of the software operation log and time of the consumed electric power log, the time correlation being based on the first chronological data obtained by the first obtainer and the second chronological data obtained by the second obtainer; and
a merger that outputs the software operation log and the consumed electric power log in association with common time information based on the time correlation determined by the determiner.

2. The consumed electric power analyzing apparatus according to claim 1, wherein the determiner comprising:
a first binarizer that binarizes the first chronological data for each predetermined unit time into first binary data;
a second binarizer that binarizes the second chronological data for each predetermined unit time into second binary data; and
a calculator that calculates a coincidence between the first binary data obtained by the first binarizer and the second binary data obtained by the second binarizer by correlating the first binary data with the second binary data while sequentially shifting one of the first binary data and the second binary data by the predetermine unit time, and calculates the correlation between the first binary data and the second binary data when the calculated coincidence is the maximum to be the time correlation.

3. The consumed electric power analyzing apparatus according to claim 2, wherein:
the first binary data takes a value of 0 when the analysis target device is in a state of sleep while takes a value of 1 when the analysis target device is operating;
the second binary data takes a value of 0 when a consumed electric power value in the predetermined unit time is less than a first threshold while takes a value of 1 when the consumed electric power value in the predetermined unit time is equal to or more than the first threshold; and
the coincidence is a ratio of values of the first binary data coinciding with values of the second binary data to the total values in a region of correlating the the first binary data with the second binary data.

4. The consumed electric power analyzing apparatus according to claim 3, wherein:
the determiner further comprising
a first weight setter that sets first weight information in the first binary data in a unit of the pre-determined unit time when the analysis target device is in a state of deep sleep; and
a second weight setter that sets second weight information in the second binary data in a unit of the predetermined unit time when the consumed electric power value of the predetermined unit time is equal to or larger than a second threshold larger than the first threshold,
when one of a relationship between the first weight information and the second binary data and a relationship between the second weight information and the first binary data satisfies a predetermined condition, the calculator corrects the coincidence to be larger than that when the relationship does not satisfy the predetermined condition in accordance with a correction standard.

5. The consumed electric power analyzing apparatus according to claim 4, wherein the predetermined condition is one of: the second binary data taking a value of 0 at a timing when the first weight information is set; and the first binary data taking a value of 1 at a timing when the second weight information is set.

6. The consumed electric power analyzing apparatus according to claim 4, wherein the calculator modifies the correction standard in accordance with measuring noise in one of the first chronological data and the second chronological data.

7. The consumed electric power analyzing apparatus according to claim 6, wherein:
under a state where the measuring noise is lower than a predetermined standard,
when the predetermined condition is satisfied, the correction standard is multiplying the coincidence by a value equal to or larger than 1 while when the predetermined condition is not satisfied, the correction standard is multiplying the coincidence by 0.

8. The consumed electric power analyzing apparatus according to claim 6, wherein:
under a state where the measuring noise is higher than a predetermined standard,
when the predetermined condition is satisfied, the correction standard is multiplying the coincidence by a value larger than 1 while when the predetermined condition is not satisfied, the correction standard is multiplying the coincidence by a positive value, smaller than 1.

9. A method for analyzing consumed electric power comprising:
at a processor
obtaining a software operation log including first chronological data related to an operation history of an analysis target device;
obtaining a consumed electric power log including second chronological data related to an electric power value consumed by the analysis target device when carrying out software operation;
determining a time correlation between time of the software operation log and time of the consumed electric power log, the time correlation being based on the first chronological data of the software operation log and the second chronological data of the consumed electric power log; and
outputting the software operation log and the consumed electric power log in association with common time information based on the determined time correlation.

10. The method according to claim 9, further comprising:
at the processor
binarizing the first chronological data for each predetermined unit time into first binary data;
binarizing the second chronological data for each predetermined unit time into second binary data; and
calculating a coincidence between the first binary data and the second binary data by correlating the first binary data with the second binary data while sequentially shifting one of the first binary data and the second binary data by the predetermine unit time, and calculating the correlation between the first binary data and the second binary data when the calculated coincidence is the maximum to be the time correlation.

11. The method, according to claim 10, wherein:
the first binary data takes a value of 0 when the analysis target device is in a state of sleep while takes a value of 1 when the analysis target device is operating;
the second binary data takes a value of 0 when a consumed electric power value in the predetermined unit time is less than a first threshold while takes a value of 1 when the consumed electric power value in the predetermined unit time is equal to or more than the first threshold; and
the coincidence is a ratio of values of the first binary data coinciding with values of the second binary data to the total values in a region of correlating the first binary data with the second binary data.

12. The method according to claim 11, further comprising:
at the processor,
setting first weight information in the first binary data in a unit of the predetermined unit time when the analysis target device is in a state of deep sleep;
setting second weight information in the second binary data in a unit of the predetermined unit time when the consumed electric power value of the predetermined unit time is equal to or larger than a second threshold larger than the first threshold; and
when one of a relationship between the first weight information and the second binary data and a relationship between the second weight information and the first binary data satisfies a predetermined condition, correcting the coincidence to be larger than that when the relationship does not satisfy the predetermined condition in accordance with a correction standard.

13. The method according to claim 12, wherein the predetermined condition is one of: the second binary data taking a value of 0 at a timing when the first weight information is set; and the first binary data taking a value of 1 at a timing when the second weight information is set.

14. The method according to claim 12, further comprising:
at the processor,
modifying the correction standard in accordance with measuring noise in one of the first chronological data and the second, chronological data.

15. The method according to claim 14, wherein
under a state where the measuring noise is lower than a predetermined standard,
when the predetermined condition is satisfied, the correction standard is multiplying the coincidence by a value equal to or larger than 1 while when the predetermined condition is not satisfied, the correction standard is multiplying the coincidence by 0.

16. The method according to claim 14, wherein
under a state where the measuring noise is higher than a predetermined standard,
when the predetermined condition is satisfied, the correction standard is multiplying the coincidence by a value larger than 1 while when the predetermined condition is not satisfied, the correction standard is multiplying the coincidence by a positive value smaller than 1.

17. A non-transitory computer-readable recording medium having stored therein a program for causing a computer to execute consumed electric power analysis comprising:
obtaining a software operation log including first chronological data related to an operation history of an analysis target device;
obtaining a consumed electric power log including second chronological data related to an electric power value consumed by the analysis target device when carrying out software operation;
determining a time correlation between time of the software operation log and time of the consumed electric power log, the time correlation being based on the first chronological data of the software operation log and the second chronological data of the consumed electric power log; and
outputting the software operation log and the consumed electric rower log in association with common time information based on the determined time correlation.

18. The non-transitory computer-readable recording medium according to claim 17, wherein the program causes the computer to execute the consumed electric power analysis further comprising:
binarizing the first chronological data for each predetermined unit time into first binary data;
binarizing the second chronological data for each predetermined unit time into second binary data; and
calculating a coincidence between the first binary data and the second binary data by correlating the first binary data with the second binary data while sequentially shifting one of the first binary data and the second binary data by the predetermine unit time, and calculating the correlation between the first binary data and the second binary data when the calculated coincidence is the maximum to be the time correlation.

19. The non-transitory computer-readable recording medium according to claim 18, wherein
the first binary data takes a value of 0 when the analysis target device is in a state of sleep while takes a value of 1 when the analysis target device is operating;
the second binary data takes a value of 0 when a consumed electric power value in the predetermined unit time is less than a first threshold while takes a value of 1 when the consumed electric power value in the predetermined unit time is equal to or more than the first threshold; and
the coincidence is a ratio of values of the first binary data coinciding with values of the second binary data to the total values in a region of correlating the first binary data with the second binary data.

20. The non-transitory computer-readable recording medium according to claim 19, wherein the program causes the computer to execute the consumed electric power analysis further comprising:
setting first weight information in the first binary data in a unit of the predetermined unit time when the analysis target device is in a state of deep sleep;
setting second weight information, in the second binary data in a unit of the predetermined unit time when the consumed electric power value of the predetermined unit time is equal to or larger than a second threshold larger than the first threshold; and
when one of a relationship between the first weight information and the second binary data and a relationship between the second weight information and the first binary data satisfies a predetermined condition, correcting the coincidence to be larger than that when the relationship does not satisfy the predetermined condition in accordance with a correction standard.
